(19) United States
(12) Patent Application Publication
(10) Pub. No.: US 2002/0035485 A1
(43) Pub. Date: Mar. 21, 2002

(54) Medical data sharing method and medical data sharing system using the method

(75) Inventors: Osamu Mita, Gamagori-shi (JP); Norimasa Hayashi, Toyohashi-shi (JP)

Correspondence Address: OLIFF & BERRIDGE, PLC, P.O. BOX 19928, ALEXANDRIA, VA, 22320, US

(73) Assignee: NIDEK CO., LTD., GAMAGORI-SHI (JP)

(21) Appl. No.: 09/950,585

(22) Filed: Sep. 13, 2001

(30) Foreign Application Priority Data
Sep. 18, 2000 (JP) 2000-286873

(51) Int. Cl. G06F 17/60

(52) U.S. Cl. 705/2; 705/67

(57) ABSTRACT

A medical data sharing method for sharing medical data through a communication network, the method including the steps of entering medical data of a patient and data on a peculiar physical feature read from the patient in a database connected to a data providing side server; requesting the medical data of the patient from a data requesting side terminal to the data providing side server through the communication network, and transmitting the peculiar physical feature data read from the patient; collating, in the server, the physical feature data of the patient transmitted from the terminal with the physical feature data of the patient stored in the database; and transmitting the medical data of the patient stored in the database from the server to the terminal through the communication network in response to the data request from the terminal only when a collation result indicates a match.

### BACKGROUND OF THE INVENTION

1. Field of the Invention

The present invention relates to a medical data sharing method for sharing medical data of a patient among plural medical facilities or others through a communication network, and a medical data sharing system using such the method.

2. Description of Related Art

Various medical data have been managed with a personal computer (hereinafter, referred to “PC”) or the like. For instance, the data managed with PCs in the ophthalmological medical field includes image data taken by a slit-lamp microscope, an eye fundus camera, etc. and measurement data measured by a tonometer and others.

Conventionally, the above medical data have been managed only in each individual medical facility. In recent years, on the other hand, there has been proposed a system to share medical data among plural facilities through a communication network such as the Internet.

To buy a corrective good or tool for correcting eye refractive power, conventionally, a patient usually brings a prescription received in a medical facility such as a clinic or hospital to a spectacles store or contact lens shop, which produces spectacles or contact lenses as prescribed. If the medical data is shared through the communication network, the shop or store may retrieve the prescription from a computer in the medical facility.

Such sharing of medical data enables relevant shops or stores to efficiently obtain the medical data of each individual patient. However, there is also a risk that the individual patient data may be leaked. This risk causes problems in security to protect the privacy of individuals and to prevent leakage of the medical data.

### SUMMARY OF THE INVENTION

The present invention has been made in view of the above circumstances and has an object to overcome the above problems and to provide a medical data sharing method capable of more securely protecting individual privacy and a medical data sharing system using the method.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a medical data sharing method for sharing medical data through a communication network, the method including the steps of: entering medical data of a patient and data on a peculiar physical feature read from the patient in a database connected to a data providing side server; requesting the medical data of the patient from a data requesting side terminal to the data providing side server through the communication network, and transmitting the peculiar physical feature data read from the patient; collating, in the server, the physical feature data of the patient transmitted from the terminal with the physical feature data of the patient stored in the database; and transmitting the medical data of the patient stored in the database from the server to the terminal through the communication network in response to the data request from the terminal only when a collation result indicates a match.

According to another aspect of the present invention, there is provided a medical data sharing system for sharing medical data through a communication network, the system including: a data providing side server provided with a database in which medical data of a patient and data on a peculiar physical feature read from the patient are stored; and a data requesting side terminal which transmits the physical feature data read from the patient to the server at the time of requesting the medical data of the patient to the server through the communication network; wherein the server collates the physical feature data of the patient transmitted from the terminal with the physical feature data of the patient stored in the database and, only when a collation result indicates a match, transmits the medical data of the patient stored in the database to the terminal through the communication network in response to the data request from the terminal.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a view of a schematic structure of a medical data management system in an embodiment according to the present invention;

FIG. 2 is a view of a log-in screen;

FIG. 3 is a view of a selection screen for entry and browse;

FIG. 4 is a view of a patient ID screen;

FIG. 5 is a view of a measurement data screen;

FIG. 6 is a view of an image data screen;

FIG. 7 is a view showing a list of data providing facilities;

FIG. 8 is a view of a fingerprint collation screen;

FIG. 9 is a flowchart to explain an authentication procedure by collation of fingerprints of a data requesting person or a patient; and

FIG. 10 is a view of a screen for the propriety of provision of every image data.

### DETAILED DESCRIPTION OF THE PREFERRED EMBODIMENTS

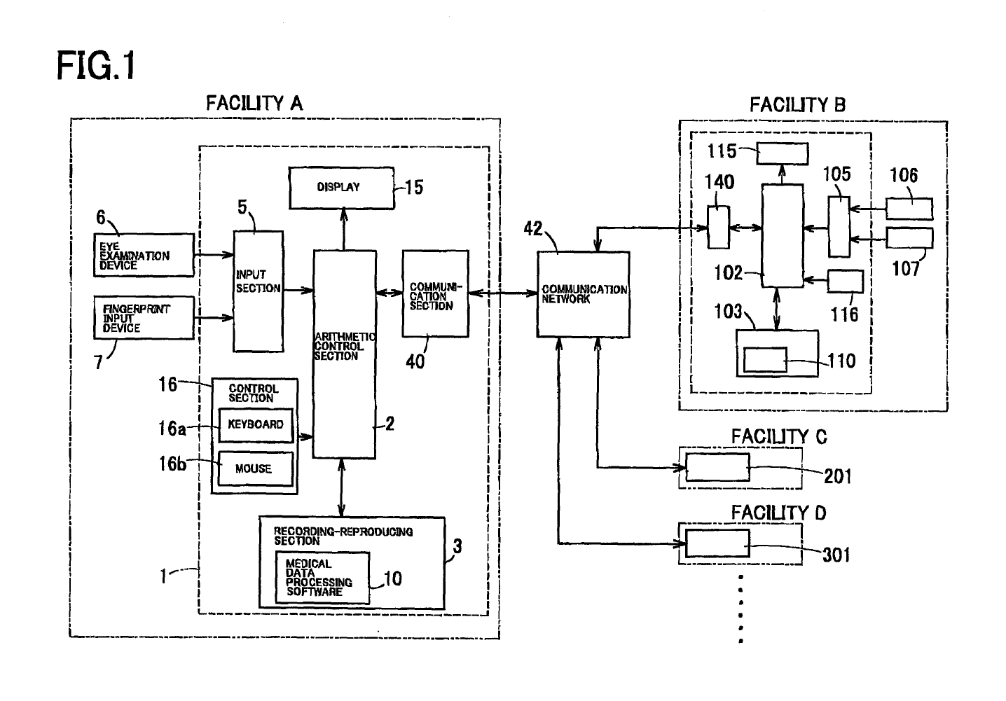

A detailed description of a preferred embodiment of a medical data sharing method and system embodying the present invention will now be given referring to the accompanying drawings. FIG. 1 is a schematic view of a structure of a medical data management system for sharing ophthalmological medical data among plural facilities in the present embodiment.

A personal computer (PC) 1 installed in a facility A is provided with an arithmetic control section 2, a recording and reproducing section (nonvolatile memory) 3 constituted of a hard disc drive, an input section 5 for inputting data from various kinds of eye examination devices 6, a communications section 40 for performing data communications with respect to outside PCs, a control section 16 including a keyboard 16a and a mouse 16b, and a display 15. The recording and reproducing section 3 serves as a database for storing medical data. The PC 1 functions as both of a server for managing files stored in the recording and reproducing section 3 and a terminal.

In the recording and reproducing section 3, a medical data processing software 10 mentioned later is recorded. When this software 10 is started, the system can be used.

The input section 5 is connected to the eye examination devices 6 such as a lensmeter, an auto-refractometer, an eye fundus camera, and a slit-lamp microscope. Measured data and image data obtained by the eye examination devices 6 are taken in the PC 1 through the input section 5.

The input section 5 is also connected to a fingerprint input device 7. This device 7 reads the image data of fingerprints to obtain their features in the form of fingerprint data. The arithmetic control section 2 has the function of collating the fingerprint data input by the input device 7 with the registered fingerprint data previously stored in the recording and reproducing section 3 to determine whether the input fingerprint data coincides with the registered fingerprint data.

A modem and a LAN board are set in the communications section 40, whereby the PC 1 in the facility A can carry out intercommunications with personal computers (PC) 101, 201, 301 and other PCs put in facilities B, C, D and other facilities through a communication network 42 such as the Internet or the like. As with the PC 1, the PC 101 in the facility B is provided with an arithmetic control section 102, a recording and reproducing section 103 having medical data processing software 110, an input section 105, a communications section 140, a control section 116, and a display 115, etc. The input section 105 is connected to an eye examination device 106 and a fingerprint input device 107. The facilities C, D and others are similarly structured and their details are omitted.

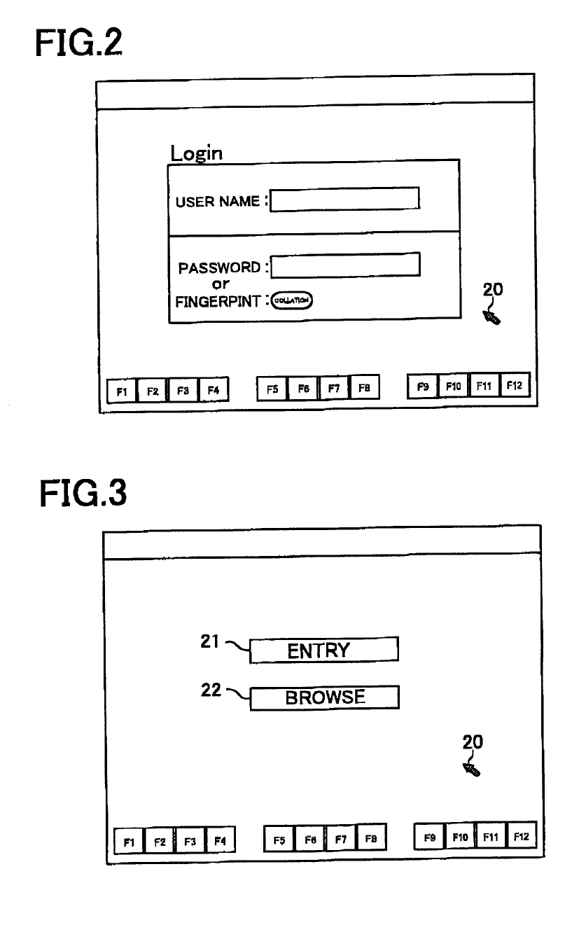

Next, an entry of medical data to a database is explained. As an example, the PC 1 in the facility A is used for the data entry. When the software 10 is started, the arithmetic control section 2 reads the software 10 from the recording and reproducing section 3 to display a log-in screen on the display 15 as shown in FIG. 2. An entry person manipulates the mouse 16a to move a cursor 20 onto items to be entered and inputs a user name and a password by operation of a keyboard 16b. The user name and the password have been assigned to a person authorized to handle medical data, e.g., a doctor, and stored in the arithmetic control section 2. The arithmetic control section 2 compares the user name and the password entered with the keyboard 16a with the previously stored ones. When they match up, the entry person is permitted to use the software 10. Alternatively, instead of entering the password, a fingerprint of the entry person may be utilized. In this case, the fingerprint input device 7 reads the fingerprint of the entry person, and the arithmetic control section 2 compares the fingerprint of the entry person input by the device 7 with the previously stored fingerprint data to check if they match up. When it is confirmed that the entry person is a person authorized to handle medical data, the entry person is permitted to log in.

Upon completion of the log-in, as shown in FIG. 3, a selection screen is displayed in which an icon 21 for data entry and an icon 22 for data browse appear. The entry person uses the mouse 16b to point the cursor 20 to the Entry icon 21 and clicks on it.

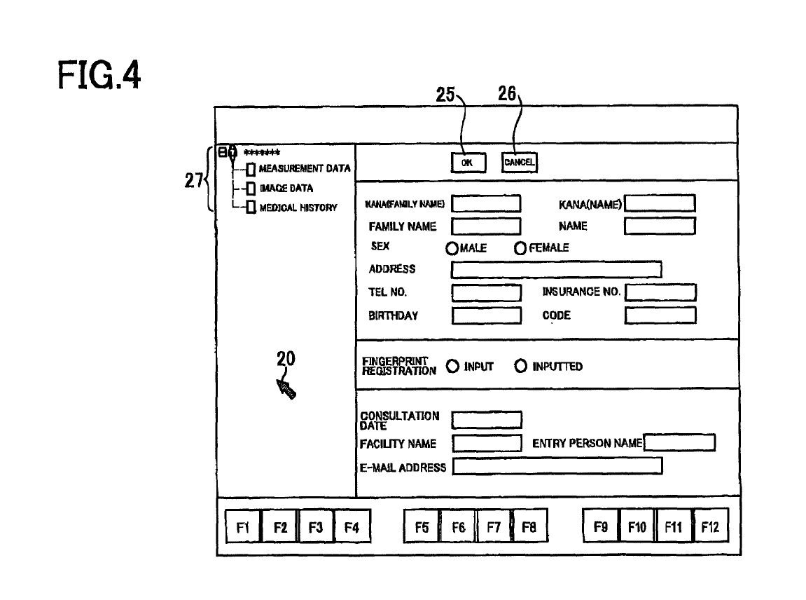

When the Entry icon 21 is selected, a patient ID screen as shown in FIG. 4 is displayed. Patient data items to be entered are “Name”, “(Japanese) Kana”, “Sex”, “Address”, “Telephone number”, “Insurance number”, “Birthday”, and “Code”. After entered the patient data, the entry person points the cursor 20 to “Input” of an item “Fingerprint registration” and clicks on it to input the fingerprint data of the patient by means of the fingerprint input device 7. The input fingerprint data is stored in correspondence with the patient data to be entered subsequently. Upon completion of input of the fingerprint data, a white circular mark at the left of “Inputted” turns black, indicating that the fingerprint data has been inputted. The data about the entry person who logged in is automatically displayed in items “Consultation date”, “Facility name”, “Entry person name”, and “E-mail address”. The items “Consultation date”, “Facility name”, “Entry person name”, and “E-mail address” may be changed by operation of the keyboard 16a and the mouse 16b. After all the items are inputted, the entry person presses an OK button 25 to complete the entry to the patient ID screen. If the entry person wants to cancel the entry, he presses a Cancel button 26.

After completion of the entry of the patient ID, measurement data, image data, and medical history of the patient are entered. On the left side of the screen, as shown in FIG. 4, icons of measurement data, image data, and medical history are displayed in hierarchical form (a treelike view 27). To enter the measurement data, the entry person points the cursor 20 to “Measurement data” and clicks on it.

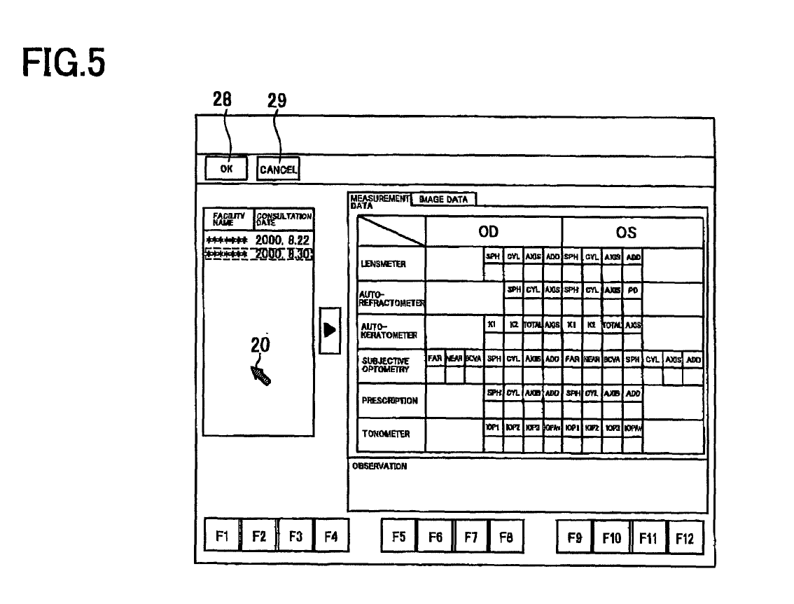

When the measurement data is selected, the screen is changed to a measurement data screen shown in FIG. 5. The measurement data is transmitted online from the eye examination devices 6 individually. The measurement data includes measured values of the spectacles lenses measured by a lensmeter (each refractive power of the lenses that the patient has worn), objective refractive power values measured by a refractometer, corneal shapes measured by a keratometer, measured values by a subjective optometry device, prescription values based on the optometry, and intraocular pressure values measured by a tonometer. The measurement data may also manually be input with the keyboard 16a and the mouse 16b. “Observation” may manually be entered. The “Facility name” and “Consultation date” entered on the patient ID screen are simultaneously displayed on the left side of the screen. When all the items are entered, the entry person presses an OK button 28. Alternatively, he presses a Cancel button 29 to cancel the entry

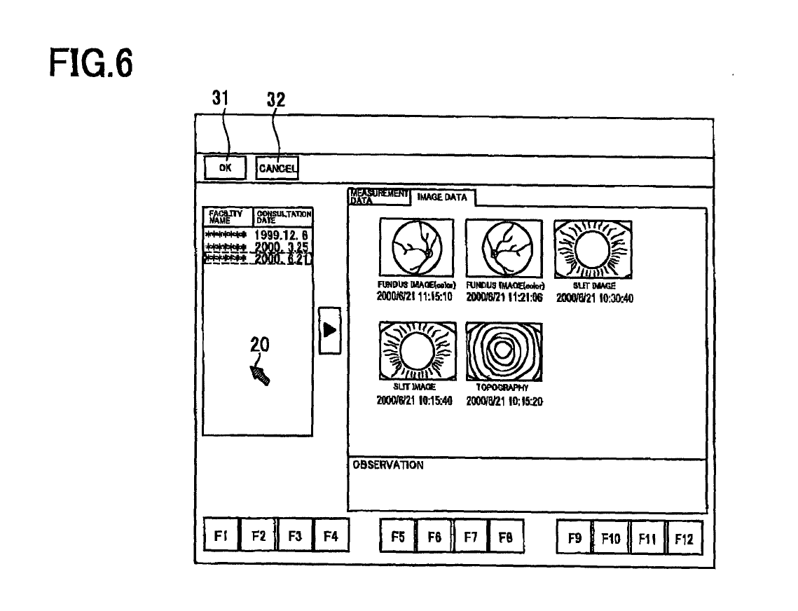

When the image data is selected on the patient ID screen shown in FIG. 4, on the other hand, the screen is changed to an image data screen shown in FIG. 6, showing images of the eye fundus photographed by the fundus camera, images photographed by the slit-lamp microscope, and other images. This entry of the image data is carried out as in the case of the entry of the measurement data.

When the medical history is selected on the patient ID screen, similarly, a medical history display screen not illustrated is displayed so that the medical history of the patient is entered with the keyboard 16a and the mouse 16b.

Next, explanation is made on a manner to browse the medical data stored in a PC in another facility. In the following example, the medical data about a patient X that has been stored in as above and managed by the PC 110 in the facility B is browsed on the PC 1 in the facility A.

At first, a data requesting person in the facility A manipulates the mouse 16b to point the cursor 20 on the log-in screen shown in FIG. 2 to the items to be entered, and operates the keyboard 16a to enter the user name and the password. Instead of entering the password, as described above, the requesting person may log in by using the fingerprint device 7 in the same way as the aforementioned data entry manner.

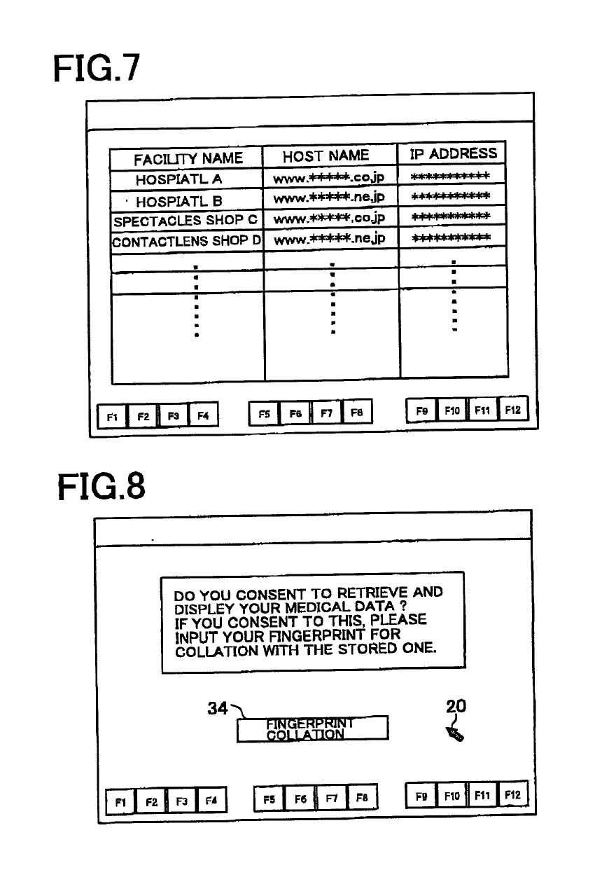

Upon log-in, the screen shown in FIG. 3 appears. The operator clicks on the Browse icon 22 on the screen. It is to be noted that data exchanges are approved in advance between the data receiving side computer and the data transmitting side computer to permit the use of this system. The other parties previously approved are stored in a list of data providing facilities as shown in FIG. 7. This list showing a facility name, a host name, an IP address can be referred to by operation of a function key.

Upon click-on the Browse icon 22, as in the above data entry manner, the patient ID screen shown in FIG. 4 appears. The data requesting person enters the name of the patient X and his other ID data. Then, the requesting person clicks on “Input” of the item “Fingerprint registration”, a fingerprint collation screen shown in FIG. 8 appears. This screen is shown to the patient X in order to confirm whether the patient consents to access to retrieve personal data (medical data). To make it easier for the patient to understand, the PC 1 may also produce a voice message that “Do you consent to retrieve and display your medical data? If you consent to this, please input your fingerprint for collation with the stored one.”

The patient X inputs his fingerprint by himself with the fingerprint input device 7. This shows his intention of consenting to retrieve the personal data from the other facility. After input of the patient's fingerprint data, the requesting person clicks on the fingerprint collation button 34. The PC 1 then transmits the fingerprint data together with the user data and the patient ID data to the PC 101 in the facility B, the PC 201 in the facility C, and other PCs through the communication network 42.

In response to the request from the PC 1, the arithmetic control section 102 of the PC 101 in the facility B checks whether the data requesting party is a previously approved facility and, sequentially, searches the recording and reproducing section 103 by the patient ID such as the name to find the medical data of the patient X. If the arithmetic control section 102 retrieves the medical data of the patient X from the recording and reproducing section 103, then it checks whether the stored fingerprint data matches with the fingerprint data transmitted from the PC 1. Thus, the two fingerprint data are collated. If they match up, the control section 102 transmits that effect to the PC 1 in the facility A. The same action as in the facility B is performed in the other facilities C, D, and others.

In this way, the consent to the retrieval of the personal data can be ensured in the presence of the patient X. At the retrieval, a peculiar physical feature that the patient himself always possesses is used as the key to the data browse. As compared with the use of a password, an ID card, etc., therefore, there are no fear that it is stolen by another person or forgotten, so that the patient can be surely identified to be a person himself.

The PC 1 in a data requesting side causes the display 15 to display the message that the fingerprints match up and the names of the facilities providing the personal data of the patient. The data requesting person confirms that effect. Then, the medical data of the patient X stored in the recording and reproducing section 103 of the PC 101 in the facility B is transmitted to the PC 1 through the communication network 42. The medical data can be browsed on the PC 1 in the following manner.

The data entry screen shown in FIG. 4 is used in common for data browse. The data requesting person clicks on an icon corresponding to the data that he wants to look among the icons of measurement data, image data, and medical history displayed in treelike form on the left side of the screen. Upon selection of the measurement data, for example, the screen is changed to the measurement data screen shown in FIGS. 5. When the requesting person selects a desired facility and consultation date from the list on the left side of the screen, the measurement data measured in the designated facility is displayed.

On the other hand, when the image data icon is selected on the patient ID screen in FIG. 4, the screen is changed to the image data screen shown in FIG. 6. The image data can be browsed as in the case of the measurement data. Similarly, when the medical history icon is selected on the patient ID screen, the screen not illustrated showing the medical history of the patient appears.

In consideration of exchanging the above medical data through the communication network 42, the transmitting side PC transmits all the data in encrypted form and the receiving side PC decrypts the received data into browsable form in order to prevent damages by a cracker or the like, thereby increasing the data security. Furthermore, in order to prevent the medical data from being browsed later while the patient is absent there, the fingerprint data of the patient used at the time of the collation for browse is not stored in the PC in the facility where the browse is requested. For example, the data receiving side PC deletes the fingerprint data of the patient after received the stored medical data from the data transmitting side PC.

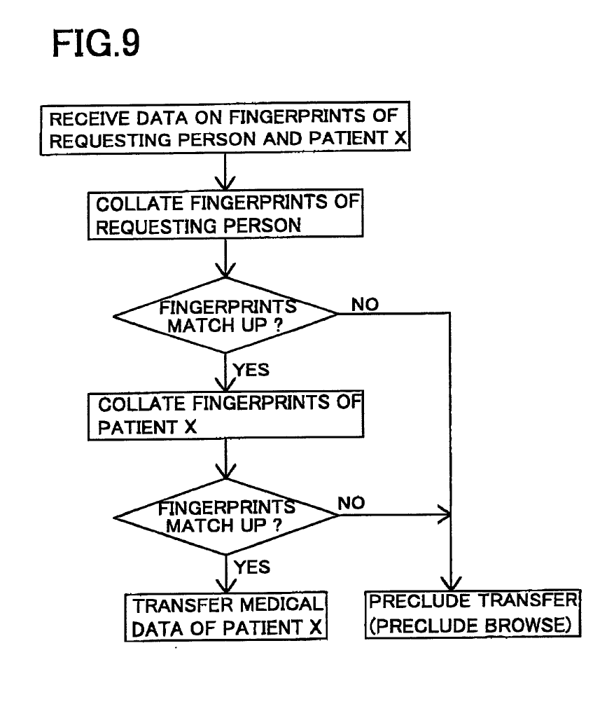

In the case of providing medical data of a patient to another facility, a data providing facility needs higher levels of security. Accordingly, a step of authenticating whether a data requesting person is the person previously authorized may be added to the above steps in order to enhance the security of medical data. For example, in the above case where a person in the facility A requests the medical data of the patient X from the facility B, the fingerprint data of the data requesting person is transmitted to the PC 101 in the facility B. The PC 101, in which the fingerprint data of the data requesting person in the facility A has previously been stored, compares the fingerprint data transmitted from the facility A with the previously stored fingerprint data. Only when the two data match up, the PC 101 transmits the medical data of the patient X to permit the browse of the data on the PC 1 in the facility A (see FIG. 9).

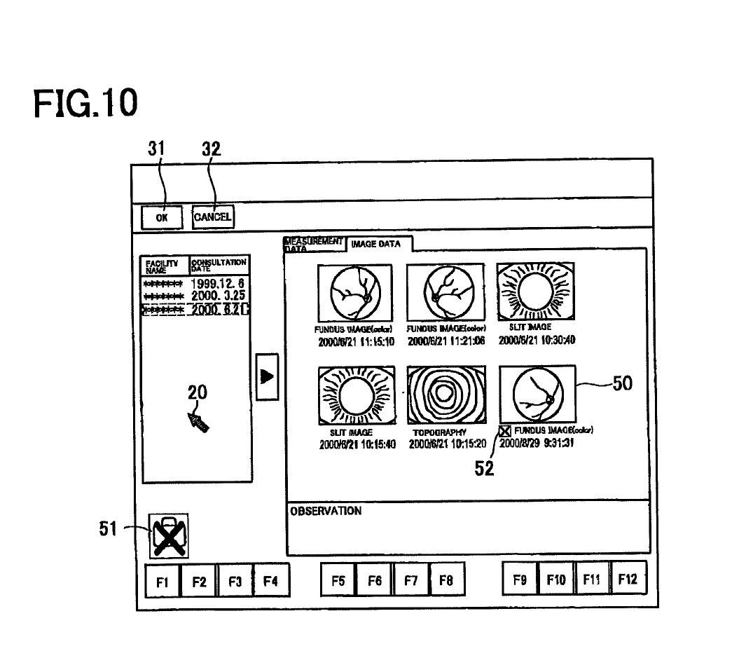

In the facility side that provides medical data of a patient to another facility, the medical data may be categorized based on the propriety of provision to another facility, or whether the provision is possible or not. An example thereof is shown in FIG. 10. When a data manager such as a doctor judges that image data 50 is impossible to provide (transfer) to other facilities because of poor image quality or some other reasons, the manager clicks on the image data 50 to select it and clicks on a provision preclusion button 51. The image data 50 is given a mark 52 showing that the provision of the corresponding data is precluded. Thereafter, the arithmetic control section 102 manages the data in a provision precluded state. This judgement may also be made on each file of the image data, measurement data, and medical history or each individual patient, besides each data as above.

The present invention may be embodied in other specific forms without departing from the spirit or essential characteristics thereof. For instance, in the above embodiment, each fingerprint of the patient, the data requesting person, and others, is used as an individual peculiar physical feature to determine the identity. Besides the fingerprint, voice, iris, and eye fundus image may be used as features for identifying a person himself. Furthermore, those features may be used in combination.

According to the present invention, the medical data can be shared with higher protection of individual privacy.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A medical data sharing method for sharing medical data through a communication network, the method including the steps of:
entering medical data of a patient and data on a peculiar physical feature read from the patient in a database connected to a data providing side server;
requesting the medical data of the patient from a data requesting side terminal to the data providing side server through the communication network, and transmitting the peculiar physical feature data read from the patient;
collating, in the server, the physical feature data of the patient transmitted from the terminal with the physical feature data of the patient stored in the database; and
transmitting the medical data of the patient stored in the database from the server to the terminal through the communication network in response to the data request from the terminal only when a collation result indicates a match.

2. The medical data sharing method according to claim 1 further including a step of authenticating whether a person requesting the medical data with the terminal is a person previously authorized to request medical data by using data on a peculiar physical feature read from the data requesting person.

3. The medical data sharing method according to claim 2, wherein the authenticating step includes:
a step of transmitting the peculiar physical feature data of the requesting person from the terminal to the server through the communication network; and
a step of collating, in the server, the transmitted physical feature data of the requesting person with peculiar physical feature data of the person previously authorized and stored in the database.

4. The medical data sharing method according to claim 1, wherein the entering step includes a step of previously categorizing the medical data data-by-data or patient-by-patient based on a propriety of provision of the medical data to a person who requests the medical data.

5. The medical data sharing method according to claim 1, wherein the physical feature data includes at least one of fingerprint data, voice data, iris data, and eye fundus data.

6. The medical data sharing method according to claim 1 further including a step of deleting the physical feature data of the patient from the terminal after the medical data of the patient stored in the database is transmitted to the terminal.

7. A medical data sharing system using the medical data sharing method according to claim 1 to share the medical data.

8. A medical data sharing system for sharing medical data through a communication network, the system including:
a data providing side server provided with a database in which medical data of a patient and data on a peculiar physical feature read from the patient are stored; and
a data requesting side terminal which transmits the physical feature data read from the patient to the server at the time of requesting the medical data of the patient to the server through the communication network;
wherein the server collates the physical feature data of the patient transmitted from the terminal with the physical feature data of the patient stored in the database and, only when a collation result indicates a match, transmits the medical data of the patient stored in the database to the terminal through the communication network in response to the data request from the terminal.

9. The medical data sharing system according to claim 8, wherein the server authenticates whether a person requesting the medical data with the terminal is a person previously authorized to request medical data by using data on a peculiar physical feature read from the data requesting person.

10. The medical data sharing system according to claim 9, wherein the terminal transmits the peculiar physical feature data of the requesting person to the server through the communication network, and
the server collates the peculiar physical feature data of the requesting person transmitted from the terminal with peculiar physical feature data of the person previously authorized and stored in the database.

11. The medical data sharing system according to claim 8, wherein the database stores the medical data after previously categorizing the medical data data-by-data or patient-by-patient based on a propriety of provision of the medical data to a person who requests the medical data.

12. The medical data sharing system according to claim 8, wherein the physical feature data includes at least one of fingerprint data, voice data, iris data, and eye fundus data.

13. The medical data sharing system according to claim 8, wherein the terminal deletes the physical feature data of the patient after the medical data of the patient stored in the database is transmitted to the terminal.

14. The medical data sharing system according to claim 8 including at least two computers serving as the server and the terminal which are disposed in different places.
